(19) United States
(12) Patent Application Publication
(10) Pub. No.: US 2023/0239407 A1
(43) Pub. Date: Jul. 27, 2023

(54) COMMUNICATION SYSTEM AND EVALUATION METHOD

(71) Applicants: KABUSHIKI KAISHA TOSHIBA, Tokyo (JP); TOSHIBA DIGITAL SOLUTIONS CORPORATION, Kawasaki-shi, Kanagawa (JP)

(72) Inventors: Atsushi KAKEMURA, Kokubunji, Tokyo (JP); Satoshi SONOH, Chigasaki, Kanagawa (JP); Kentaro FURIHATA, Kawasaki-shi, Kanagawa (JP)

(73) Assignees: KABUSHIKI KAISHA TOSHIBA, Tokyo (JP); TOSHIBA DIGITAL SOLUTIONS CORPORATION, Kawasaki-shi, Kanagawa (JP)

(21) Appl. No.: 18/004,521

(22) PCT Filed: Jul. 15, 2021
(86) PCT No.: PCT/JP2021/026571

§ 371 Date: Jan. 6, 2023

(30) Foreign Application Priority Data
Jul. 27, 2020 (JP) 2020-126410

(51) Int. Cl. H04M 3/56; G10L 15/08; G10L 15/22; G10L 15/30

(52) U.S. Cl. CPC H04M 3/568; G10L 15/08; G10L 15/22; G10L 15/30; G10L 2015/088

(57) ABSTRACT

A communication system is configured to broadcast utterance voice data received from one of mobile communication terminals to other mobile communication terminals, to control text delivery such that a result of utterance voice recognition from voice recognition processing on the received utterance voice data is displayed on the mobile communication terminals in synchronization, and to use the result of utterance voice recognition to perform communication evaluation. The communication evaluation includes a first evaluation including evaluating a dialogue between users based on a group dialogue index to produce group communication evaluation information, a second evaluation including evaluating utterances constituting the dialogue between the users based on a personal utterance index to produce personal utterance evaluation information, and a third evaluation including using the group communication evaluation information and the personal utterance evaluation information to produce entire communication group evaluation information.

### TECHNICAL FIELD

Embodiments of the present invention generally relate to a technique for assisting in communication using voice and text (for sharing of recognition, conveyance of intention and other purposes), and more particularly, to a communication evaluation technique.

### BACKGROUND ART

Communication by voice is performed, for example, with transceivers. A transceiver is a wireless device having both a transmission function and a reception function for radio waves and allowing a user to talk with a plurality of users (to perform unidirectional or bidirectional information transmission). The transceivers can find applications, for example, in construction sites, event venues, and facilities such as hotels and inns. The transceiver can also be used in radio-dispatched taxis, as another example.

### PRIOR ART DOCUMENTS

### Patent Documents

[Patent Document 1] Japanese Patent Laid-Open No. 2014-86942
[Patent Document 2] Japanese Patent Laid-Open No. 2018-7005

### DISCLOSURE OF THE INVENTION

### Problems to Be Solved by the Invention

It is an object of the present invention to perform evaluation of entire group utterances of a communication group and evaluation of personal (individual) utterances in the group utterance to assist in improved quality of information transmission.

### Means for Solving the Problems

In a communication system according to embodiments, a plurality of users carry their respective mobile communication terminals, and a voice of utterance of one of the users input to his mobile communication terminal is broadcast to the mobile communication terminals of the other users. The communication system includes a communication control section including a first control section configured to broadcast utterance voice data received from one of the mobile communication terminals to the other mobile communication terminals and a second control section configured to control text delivery such that the result of utterance voice recognition from voice recognition processing on the received utterance voice data is displayed on the mobile communication terminals in synchronization; and an evaluation control section configured to use the result of utterance voice recognition to perform communication evaluation. The evaluation control section includes a first evaluation section configured to evaluate a dialogue between two or more of the users based on a group dialogue index to produce group communication evaluation information, a second evaluation section configured to evaluate utterances constituting the dialogue between the two or more of the users based on a personal utterance index to produce personal utterance evaluation information, and a third evaluation section configured to use the group communication evaluation information and the personal utterance evaluation information to produce entire communication group evaluation information.

### BRIEF DESCRIPTION OF THE DRAWINGS

FIG. 1 A diagram showing the configuration of a network of a communication system according to Embodiment 1. FIG. 2 A block diagram showing the configurations of a communication management apparatus and a user terminal according to Embodiment 1.

FIG. 3 A diagram showing exemplary user information and exemplary group information according to Embodiment 1.

FIG. 4 A diagram showing exemplary screens displayed on user terminals according to Embodiment 1.

FIG. 5 A diagram showing exemplary extraction from group utterance for group dialogue evaluation and personal utterance evaluation according to Embodiment 1.

FIG. 6 Graphs showing exemplary evaluation based on group dialogue indices according to Embodiment 1.

FIG. 7 Graphs showing exemplary evaluation based on personal utterance indices according to Embodiment 1.

FIG. 8 A diagram for explaining an evaluation method according to Embodiment 1.

FIG. 9 A diagram showing an example of entire communication evaluation information mapped in a biaxial evaluation field according to Embodiment 1 (illustrating a comparison between communication groups).

FIG. 10 A diagram showing an example of entire communication evaluation information mapped in the biaxial evaluation field according to Embodiment 1 (illustrating a monthly comparison in the same group).

FIG. 11 A diagram showing exemplary setting of weight values to the evaluation indices according to Embodiment 1.

FIG. 12 A diagram showing an example of evaluation information added to a communication log synchronized for display on user terminals according to Embodiment 1.

FIG. 13 A diagram showing a flow of processing performed in the communication system according to Embodiment 1.

FIG. 14 A diagram showing a flow of processing performed in the communication system according to Embodiment 1, and illustrating real-time evaluation and delivery of the evaluation result in combination with broadcast.

### MODE FOR CARRYING OUT THE INVENTION

### (Embodiment 1)

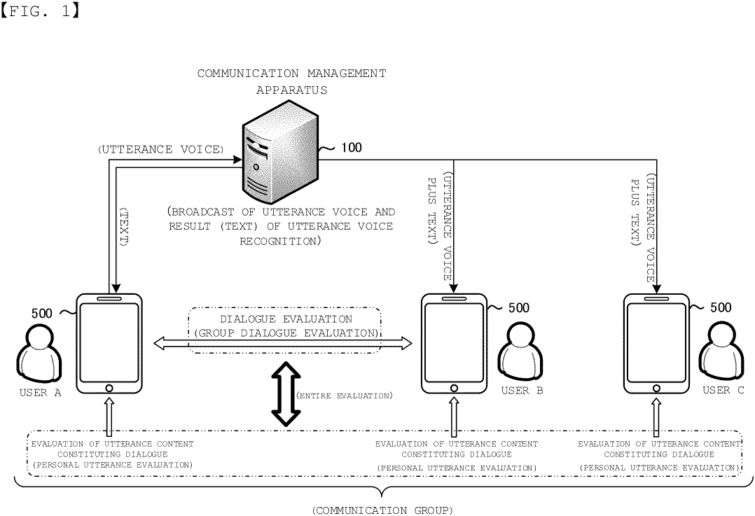

FIGS. 1 to 14 are diagrams showing the configuration of a network of a communication system according to Embodiment 1, its functional configuration, and processing flows performed therein. The communication system provides an information transmission assistance function with the use of voice and text such that a communication management apparatus (hereinafter referred to as a management apparatus) 100 plays a central role. An aspect of applying the communication system to operation and management of facilities such as accommodations is described below, by way of example.

As shown in FIG. 1, the management apparatus 100 is connected to user terminals (mobile communication terminals) 500 carried by respective users through wireless communication. The management apparatus 100 broadcasts utterance voice data received from one of the user terminals 500 to the other user terminals 500.

The user terminal 500 may be a multi-functional cellular phone such as a smartphone, or a portable terminal (mobile terminal) such as a Personal Digital Assistant (PDA) or a tablet terminal. The user terminal 500 has a communication function, a computing function, and an input function, and connects to the management apparatus 100 through wireless communication over the Internet Protocol (IP) network or Mobile Communication Network to perform data communication.

A communication group is set to define the range in which the utterance voice of one of the users can be broadcast to the user terminals 500 of the other users (or the range in which a communication history, later described, can be displayed in synchronization). Each of the user terminals 500 of the relevant users (field users) is registered in the communication group.

The communication system according to Embodiment 1 assists in information transmission for sharing of information, conveyance of intention and other purposes based on the premise that the plurality of users can perform hands-free interaction with each other. Specifically, the communication system according to Embodiment 1 evaluates utterances of users performed for sharing of information or conveyance of intention based on indices including group dialogue indices and personal utterance indices, and then uses the evaluation results to evaluate the entire communication group.

The efficiency of works depends on communication quality of each user or a group of users participating in a conversation, including ways of talking, ways of questioning, and contents of answers to questioning. For example, when a precise instruction is provided, a person who should respond thereto can perform associated works smoothly. When a precise response is made to the instruction, a person who provided the instruction can find that the intention of the instruction was conveyed to the target user. Consequently, the works can be performed property.

In contrast, when the response to the instruction is slow and not clear, the intention of the instruction may not have been conveyed to the target user. This may lead to lowered work efficiency since it is necessary to reissue the instruction or issue another instruction to a user other than the target user to whom the first instruction was issued. When the content of the instruction is ambiguous or the response is unclear, work mistakes may occur due to erroneous recognition or erroneous transmission.

As described above, the communication quality in the entire communication group is an important factor in evaluating the work efficiency. In light of the foregoing, the communication system according to Embodiment 1 objectively evaluates utterance logs of the communication group based on two types of indices including the group dialogue index and the personal utterance index.

Group communication evaluation information produced based on the group dialogue index is used to evaluate the quality of a “dialogue” serving as an index of smooth conversations. Personal utterance evaluation information produced based on the personal utterance index is used to evaluate the quality of an “utterance” serving as an index of smooth information transmission.

The communication system performs the evaluation based on the group dialogue index and the evaluation based on the personal utterance index to achieve evaluation of the entire communication group in an evaluation field having axes corresponding to these two indices. Such a configuration allows objective evaluation of the work efficiency based on the relative relationship between the “dialogue” and “utterance” in the entire communication group. The evaluation of the group and the evaluation of the personal user are fed back, and in view of specific good and bad points in “dialogue” and “utterance,” the improved efficiency of the overall work can be facilitated as intended by each communication group.

FIG. 2 is a block diagram showing the configurations of the management apparatus 100 and the user terminal 500.

The management apparatus 100 includes a control apparatus 110, a storage apparatus 120, and a communication apparatus 130. The communication apparatus 130 manages communication connection and controls data communication with the user terminals 500. The communication apparatus 130 controls broadcast to distribute utterance voice data from one of the users and text information representing the content of the utterance (text information provided through voice recognition processing on the utterance voice data) to the user terminals 500 at the same time.

The control apparatus 110 includes a user management section 111, a communication control section 112, a voice recognition section 113, a voice synthesis section 114, and an evaluation control section 115. The storage apparatus 120 includes user information 121, group information 122, communication history (communication log) information 123, a voice recognition dictionary 124, a voice synthesis dictionary 125, and communication evaluation information 126.

The voice synthesis section 114 and the voice synthesis dictionary 125 provide a voice synthesis function of receiving a character information input of text form on the user terminal 500 or a character information input of text form on an information input apparatus other than the user terminal 500 (for example, a mobile terminal or a desktop PC operated by a manager, an operator, or a supervisor), and converting the character information into voice data. However, the voice synthesis function in the communication system according to Embodiment 1 is an optional function. In other words, the communication system according to Embodiment 1 may not have the voice synthesis function. When the voice synthesis function is included, the communication control section 112 of the management apparatus 100 receives text information input on the user terminal 500, and the voice synthesis section 114 synthesizes voice data corresponding to the received text characters with the voice synthesis dictionary 125 to produce synthesized voice data. The synthesized voice data can be produced from any appropriate materials of voice data. The synthesized voice data and the received text information can be broadcast to the other user terminals 500. It should be noted that the synthesized voice data is also accumulated in the communication history and thus can be treated as a log targeted for the evaluation function.

The user terminal 500 includes a communication/talk section 510, a communication application control section 520, a microphone 530, a speaker 540, a display input section 550 such as a touch panel, and a storage section 560. The speaker 540 is actually formed of earphones or headphones (wired or wireless). A vibration apparatus 570 is an apparatus for vibrating the user terminal 500.

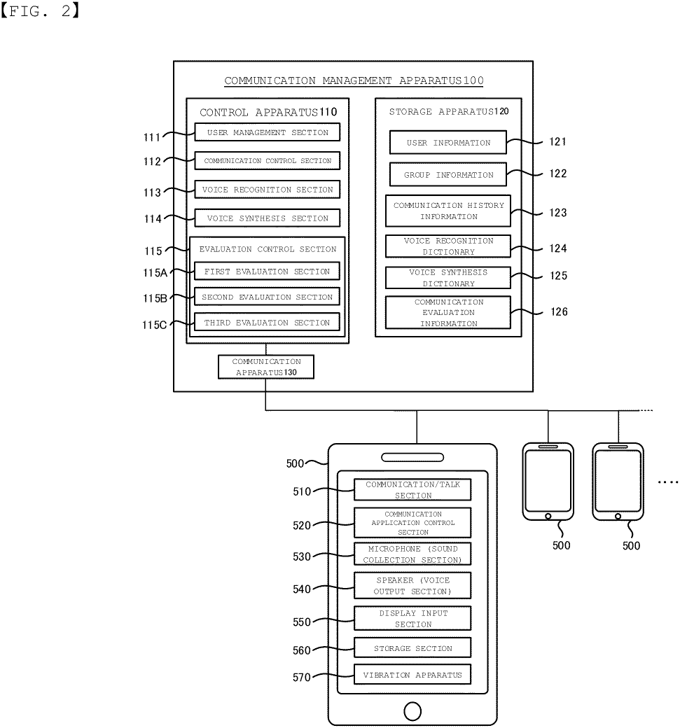

FIG. 3 is a diagram showing examples of various types of information. User information 121 is registered information about users of the communication system. The user management section 111 controls a predetermined management screen to allow setting of a user ID, user name, attribute, and group on that screen. The user management section 111 manages a list of correspondences between a history of log-ins to the communication system on user terminals 500, the IDs of the users who logged in, and identification information of the user terminals 500 of those users (such as MAC address or individual identification information specific to each user terminal 500).

Group information 122 is group identification information representing separated communication groups. The communication management apparatus 100 controls transmission/reception and broadcast of information for each of the communication groups having respective communication group IDs to prevent mixed information across different communication groups. Each of the users in the user information 121 can be associated with the communication group registered in the group information 122.

The user management section 111 according to Embodiment 1 controls registration of each of the users and provides a function of setting a communication group in which first control later described (broadcast of the utterance voice data) and second control (broadcast of the text resulting from the utterance voice recognition) are performed.

Depending on the particular facility in which the communication system according to Embodiment 1 is installed, the facility can be classified into a plurality of divisions for facility management. In an example of an accommodation facility, bellpersons (porters), concierges, and housekeepers (cleaners) can be classified into different groups, and the communication environment can be established such that hotel room management is performed within each of those groups. In another viewpoint, communications may not be required for some tasks . For example, serving staff members and bellpersons (porters) do not need to directly communicate with each other, so that they can be classified into different groups. In addition, communications may not be required from geographical viewpoint. For example, when a branch office A and a branch office B are remotely located and do not need to frequently communicate with each other, they can be classified into different groups.

The communication control section 112 of the management apparatus 100 serves as control sections including a first control section and a second control section. The first control section controls broadcast of utterance voice data received from one user terminal 500 to the other user terminals 500 (group calling control). The second control section chronologically accumulates the result of utterance voice recognition from voice recognition processing on the received utterance voice data in the user-to-user communication history 123 and controls text delivery such that the communication history 123 is displayed in synchronization on all the user terminals 500 including the user terminal 500 of the user who performed the utterance.

The function provided by the first control section is broadcast of utterance voice data. The utterance voice data mainly includes voice data representing user’s utterance. When the voice synthesis function is included as described above, the synthesized voice data produced artificially from the text information input on the user terminal 500 is also broadcast by the first control section.

The function provided by the second control section is broadcast of the text resulting from the voice recognition of user’s utterance. The voices input to the user terminals 500 and the voices reproduced on the user terminals 500 are all converted to text data which is then accumulated chronologically in the communication history 123 and displayed on the user terminals 500 in synchronization. The voice recognition section 113 performs voice recognition processing with the voice recognition dictionary 124 and outputs text data as the result of utterance voice recognition. The voice recognition processing can be performed by using any of known technologies.

The communication history information 123 is log information including contents of utterance of the users, together with time information, accumulated chronologically on a text basis. Voice data corresponding to each of the texts can be stored as a voice file in a predetermined storage region, and the position of the stored voice file is recorded in the communication history 123, for example. The communication history information 123 is created and accumulated for each communication group. The result of voice quality evaluation may be accumulated to be included in the communication history information 123, or may be associated with the evaluated utterance content and accumulated in a separate storage region.

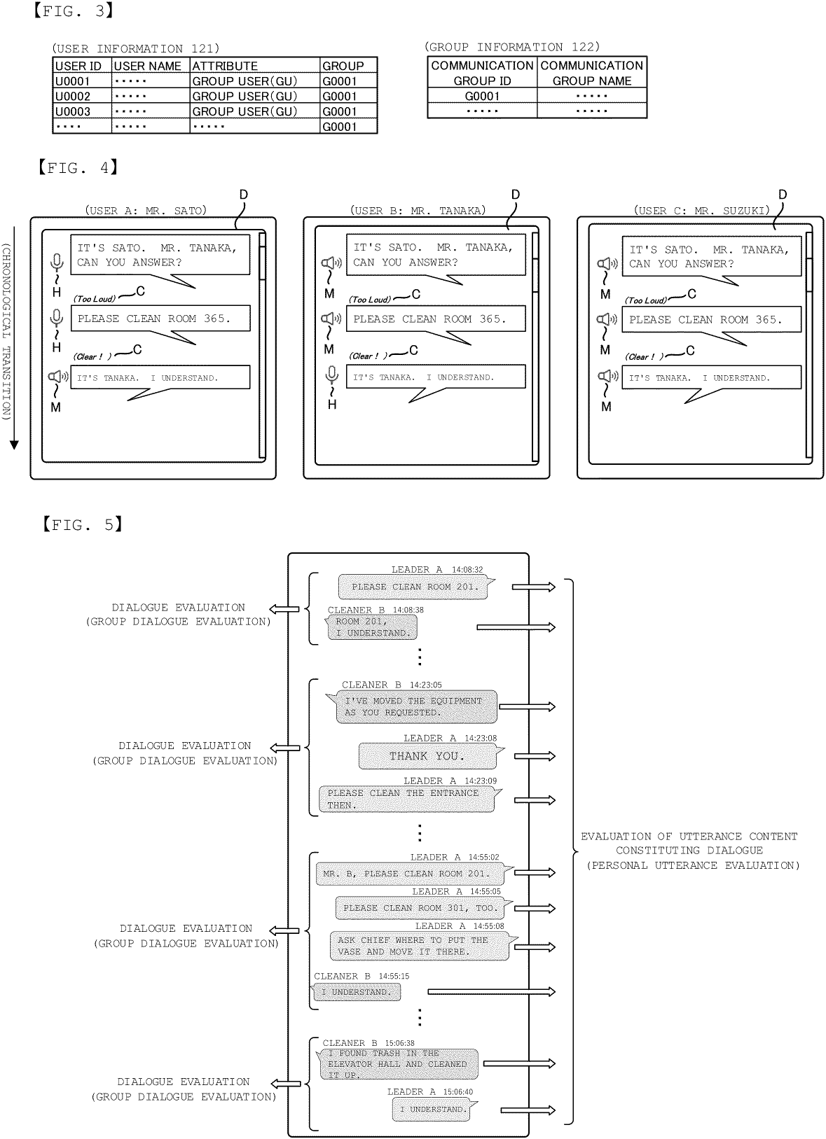

FIG. 4 is a diagram showing an example of the communication history 123 displayed on the user terminals 500. Each of the user terminals 500 receives the communication history 123 from the management apparatus 100 in real time or at a predetermined time, and the display thereof is synchronized among the users. The users can chronologically refer to the communication log.

As shown in the example of FIG. 4, each user terminal 500 chronologically displays the utterance content of the user of that terminal 500 and the utterance contents of the other users in a display field D to share the communication history 123 accumulated in the management apparatus 100 as log information. In the display field D, each text representing user’s own utterance may be accompanied by a microphone mark H, and the users other than the utterer may be shown by a speaker mark M instead of the microphone mark H in the display field D.

The communication evaluation according to Embodiment 1 is now described in detail. The evaluation control section 115 performs the communication evaluation using the result of utterance voice recognition and includes evaluation functions of a first evaluation section 115A, a second evaluation section 115B, and a third evaluation section 115C.

The first evaluation section 115A evaluates dialogues between users based on the group dialogue index to produce group communication evaluation information.

The second evaluation section 115B evaluates utterances constituting the dialogue between users based on the personal utterance index to produce personal utterance evaluation information.

The third evaluation section 115C uses the group communication evaluation information and the personal utterance evaluation information to produce entire communication group evaluation information. As later described, the entire communication group evaluation information is evaluation information provided by plotting the relative relationship between “dialogue” and “utterance” in the evaluation field having the horizontal axis and the vertical axis corresponding to the group communication evaluation information and the personal utterance evaluation information, respectively.

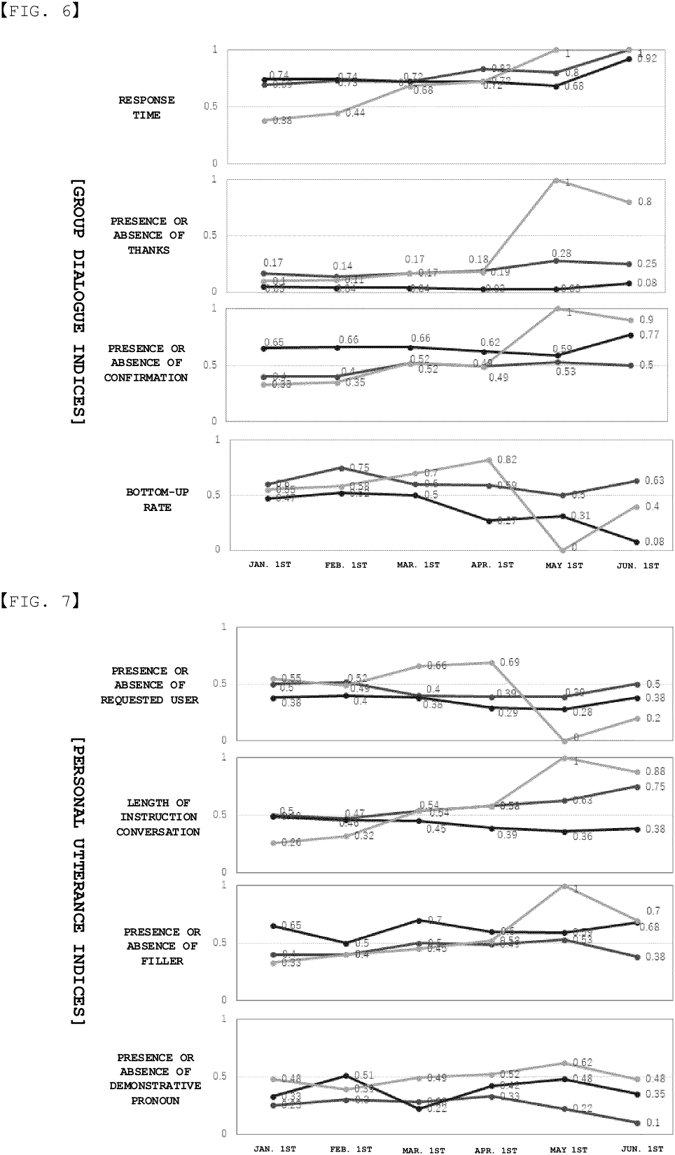

FIG. 5 is a diagram showing exemplary extraction from group utterance for group dialogue evaluation and personal utterance evaluation. As shown in FIG. 5, for the group dialogue evaluation, a group of utterances of two or more persons constituting a dialogue between a contacting user and a contacted user are extracted from the communication log as a target for evaluation. For example, ask and answer utterance examples can be preset such as “please OO” and “I understand” to identify the first and last utterance sentences to be extracted, respectively, and any group of utterances including those phrases can be extracted. Alternatively, only the first utterance sentence can be identified, and that identified sentence and a subsequent predetermined number of utterances can be extracted, or only the last utterance sentence can be identified, and that identified sentence and a preceding predetermined number of utterances can be extracted.

For the personal utterance evaluation, utterance sentences constituting the group of utterances (dialogue) extracted in the group dialogue evaluation are extracted as a target for evaluation.

The group dialogue index according to Embodiment 1 includes indices of the response time, presence or absence of thanks, presence or absence of confirmation, and bottom-up rate. The response time is an index for evaluating a user-to-user utterance response time (in seconds) and corresponds to a time period between the utterance of a contacting user and the utterance of a contacted user. The presence or absence of thanks is an exemplary index for evaluating the presence of a specified keyword in utterances constituting a dialogue, and is used, for example, to evaluate the presence or absence of a phrase (keyword) such as “Thank you” or “I appreciate your efforts” used by the contacting user to appreciate the response from the contacted user.

The presence or absence of confirmation is used to evaluate the presence or absence of a confirmative response from the contacted user to a message from the contacting user. The confirmative response is a repetition of the message, for example. The bottom-up rate relates to an extracted spontaneous action of any user. For example, what is performed in response to a message, that is, in accordance with an instruction, is a passive action, and what is performed spontaneously without any instruction is a spontaneous action. An exemplary utterance sentence for evaluating the bottom-up rate is an utterance sentence in a report of work completion, and an utterance sentence including “I have done --” or “I have done -- first” can be extracted. The management apparatus 100 can check that a predetermined number of utterance sentences before the extracted utterance sentence include no utterance sentence corresponding to a message or instruction from the contacting user. This can extract the spontaneous action in distinction from any passive action in response to a message or instruction from the contacting user.

FIG. 6 shows graphs illustrating exemplary evaluation based on the group dialog indices according to Embodiment 1. The example of FIG. 6 shows monthly evaluation of communication groups in graph form. Evaluations values are represented as rates with respect to the respective indices in a range from 0.0 to 1.0. The produced evaluation values include the rate of response times less than 30 seconds, the rate of utterance sentences of dialogues that include any keyword expressing thanks, the rate of utterance sentences in response to instructions that include any confirmation (repetition) keyword, and the rate of reporting utterances including any utterance reporting a spontaneous action.

The personal utterance index include indices of the presence or absence of a proper noun, message redundancy (the length of instruction conversation, presence or absence of a filler), and the presence or absence of a demonstrative pronoun. The proper noun corresponds to the user’s first name or last name. The message redundancy is divided into indices of the length of an instruction conversation and the presence or absence of a filler. The length of an instruction conversation is used to evaluate a plurality of messages (instruction sentences) included in a single sentence or many characters included per utterance. The presence or absence of a filler is used to evaluate any filler included in utterances such as “say,” and “well.” The demonstrative pronoun is a word indicating an item, place, or direction, and is used to evaluate an ambiguous word included in utterances such as “this,” “there,” “that,” and “over there.”

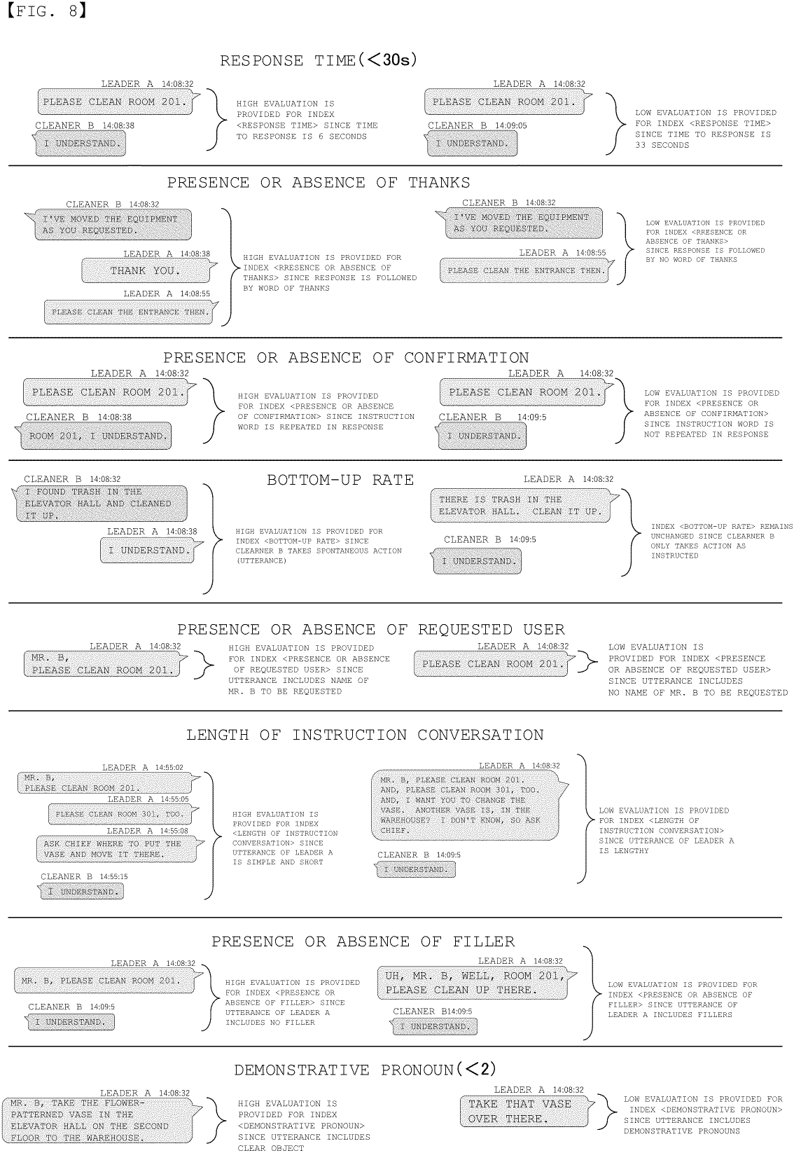

FIG. 7 shows graphs illustrating exemplary evaluation based on the personal utterance indices according to Embodiment 1. Similarly to the example of FIG. 6, the example of FIG. 7 shows monthly evaluation of communication groups in graph form. Evaluations values are represented as rate with respect to the respective indices in a range from 0.0 to 1.0. The presence or absence of a requested user relates to the rate of utterance sentences including the proper noun of a contacted user in a message. The length of an instruction conversation relates to the rate of utterance sentences having a number of characters per utterance equal to or lower than a predetermined number and/or the rate of utterance sentences including a predetermined number of or less instruction contents. The presence or absence of a filler relates to the rate of utterance sentences including a number of fillers per utterance equal to or lower than a predetermined number. The demonstrative pronoun relates to the rate of utterance sentences including two or more demonstrative pronouns in a message for instruction or other purposes.

Set values including threshold values in the respective indices such as the number of included demonstrative pronouns can be set as appropriate, and this applies to the group dialogue indices. While the evaluation values are calculated as the rates by way of example, the evaluation values may be calculated as scores. For example, a score can be added when any condition for the indices is satisfied and a score can be reduced when any condition is not satisfied, or a score can be added only when any condition is satisfied, or a score can be reduced only when any condition is not satisfied.

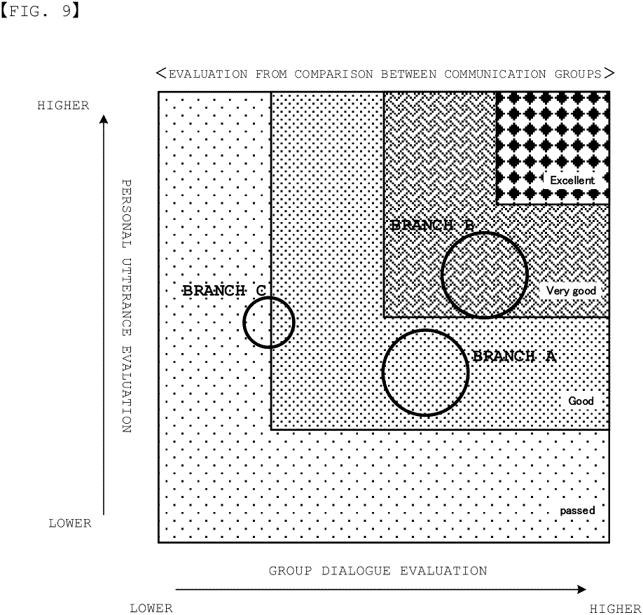

FIG. 8 is a diagram for explaining an evaluation method based on the indices. In FIG. 8, the left side shows an aspect in which a high evaluation results from calculation and the right side shows an aspect in which a low evaluation results from calculation.

The “response time” of the group dialogue index has a set value of 30 seconds. In an example on the left side, cleaner B responds to an utterance of instruction from leader A in 6 seconds, so that a high (good) evaluation is provided. In an example on the right side, the cleaner B responds in 33 seconds, so that a low (bad) evaluation is provided. As the response time to the message is shorter, the communication efficiency is higher and the work efficiency is more improved.

The “presence or absence of thanks” of the group dialogue index has an evaluation condition whether any phrase or keyword expressing thanks is included. In an example on the left side, the leader A utters the phrase “Thank you” to the response (utterance for report) from the cleaner B, so that a high evaluation is provided. In an example on the right side, the leader A utters no phrase or keyword expressing thanks to the response from the cleaner B, so that a low evaluation is provided. Expressing thanks to the user action conveys the feeling of appreciation to motivate the user to work.

The “presence or absence of confirmation” of the group dialogue index is used to evaluate whether the utterance content of the cleaner B in response to the instruction from the leader A includes a repetition of the instruction word (phrase or keyword relating to the instruction content) from the leader A. In an example on the left side, in response to the instruction utterance “please clean room 201” of the leader A, the cleaner B says “room 201, I understand” by repeating part of the instruction utterance of the leader A, “room 201,” so that a high evaluation is provided. In an example on the right side, the cleaner B only says “I understand,” and any instruction word from the leader A is not included, so that a low evaluation is provided. For smooth communication, mutual understanding of transmitted information is essential. When the contacting user can confirm that the intended content is accurately conveyed to the contacted user, this can save the contacting user the effort of making the same contact for double check. In addition, the contacted user can understand the instruction content more clearly by repeating the instruction word. In this manner, the accuracy of mutual understanding of transmitted information can be improved.

The “bottom-up rate” of the group dialogue index is used to evaluate a spontaneous action of any user. In an example on the left side, the cleaner B reports (performs utterance expressing) his spontaneous action, so that a high evaluation is provided. In an example on the right side, the cleaner B takes a passive action in response to the instruction utterance of the leader A, so that a low evaluation is provided. The “bottom-up rate” in Embodiment 1 can include not only utterances relating to the spontaneous action of the user described above, that is, the action on user’s own judgement, but also utterances relating to a spontaneous proposal or suggestion of any user, or an action at the initiative of any user, such as the utterance “it’s about time to get busy, and I’ll do inspection and replenishment works.” or “I’m free now and I’ll go help with cleaning work. Is that all right?”

The evaluation based on the bottom-up rate is an important factor in terms of work efficiency. The users can think and act on their own to improve the work efficiency.

The “presence or absence of a requested user” of the personal utterance index is used to evaluate whether a user performs utterance specifying a contacted user. In an example on the left side, the utterance includes the name of the cleaner B to be requested, so that a high evaluation is provided. In an example on the right side, the utterance includes no name of a requested user, so that a low evaluation is provided. In some cases, the contacted user may be specified, or the contacting user may wish to make contact with the entire communication group without specifying any contacted user. In the latter case, the same message is transmitted to the users of the group, and confusion may arise among the users as to which one of them should respond and take actions. To address this, the utterance specifying the contacted user is evaluated to improve the work efficiency.

The “length of an instruction conversation” of the personal utterance index is used to evaluate the redundancy of utterance content. In an example on the left side, the leader A produces simple and short utterances (messages) for respective instructions with a few characters per utterance and a few instruction contents per utterance, so that a high evaluation is provided. In an example on the right side, the leader A produces a lengthy utterance with long sentences including a plurality of instructions, so that a low evaluation is provided. When the lengthy utterance including a plurality of instructions is produced, the instruction contents are not clearly separated from each other and the accuracy of information transmission is reduced. Thus, simpler and shorter messages from the contacting user can provide higher accuracy of information transmission to improve the work efficiency.

From the same viewpoint, the “presence or absence of a filler” is used to evaluate redundancy based on any filler such as “say,” or “well,” included in utterances. As shown in FIG. 8, in an example on the left side, the utterance (message) of the leader A includes no filler and the instruction content is smoothly conveyed without interference from any filler, so that a high evaluation is provided. In an example on the right side, fillers are included and prevent smooth information transmission of the instruction content, so that a low evaluation is provided. In this manner, no or few fillers can provide higher accuracy of information transmission to improve the work efficiency.

The “demonstrative pronoun” of the personal utterance index is used to evaluate any ambiguous word such as “this,” “there,” “that,” and “over there” included in utterances. In an example on the left side, the utterance clearly specifies the name of a user to be requested, the place (the elevator hall on the second floor), and the purpose (take the flower-patterned vase to the warehouse), so that a high evaluation is provided. In an example on the right side, the place and the purpose are indicated by demonstrative pronouns, so that a low evaluation is provided. More demonstrative pronouns may be used in messages depending on the degree of communication skill, although the accuracy of information transmission is reduced when the messages do not clearly express who should perform what work, where. Thus, the work efficiency is improved by utterances including few demonstrative pronouns and clearly specifying the user to be instructed, and the place and purpose of the work requested of the user.

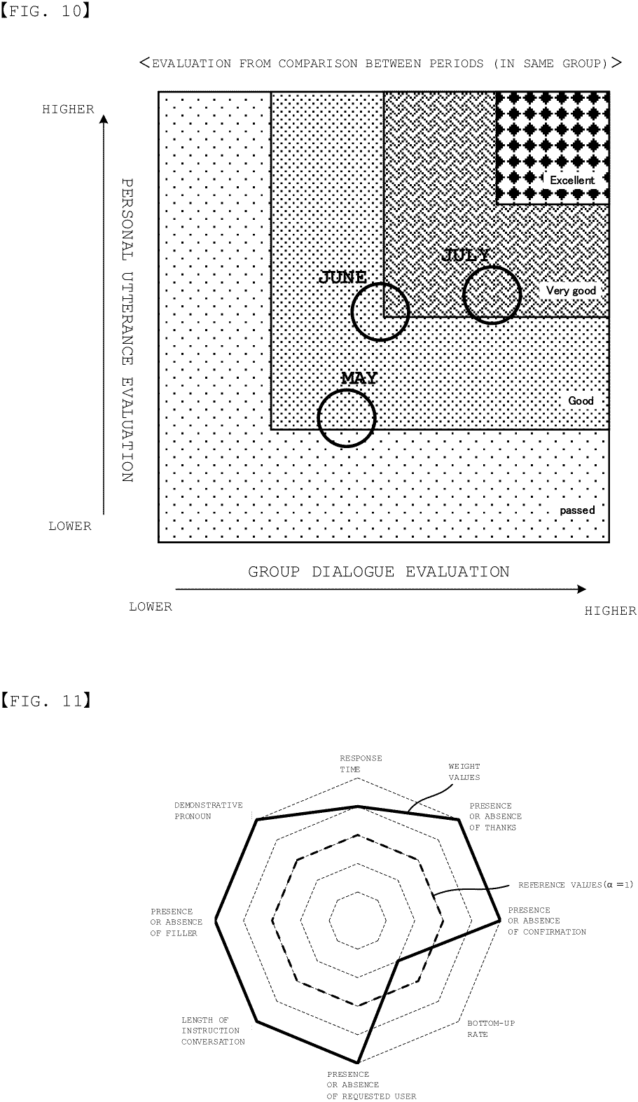

FIG. 9 is a diagram showing an example of entire communication evaluation information mapped in a biaxial evaluation field, and illustrates exemplary evaluation from comparison between communication groups.

In Embodiment 1, the entire communication group evaluation information is provided by using the result of evaluation based on the group dialogue indices (group communication evaluation information) and the result of evaluation based on the personal utterance indices (personal utterance evaluation information).

The communication system can individually provide the result of evaluation based on the group dialogue indices and the result of evaluation based on the personal utterance indices. Only the result of evaluation based on the group dialogue indices cannot evaluate each user of the group, and only the result of evaluation based on the personal utterance indices cannot reveal the actual state of the entire group. To address this, in Embodiment 1, the evaluation field represented on the vertical axis and horizontal axis is produced, and the group communication evaluation information and the personal utterance evaluation information are associated with the two axes. The result of evaluation based on the group dialogue indices and the result of evaluation based on the personal utterance indices are mapped as parameters in the evaluation field to produce the entire communication group evaluation information. The size of circles corresponds to the amount of utterance (number of utterance sentences to be evaluated), with a bigger circle indicating a larger amount of utterance.

FIG. 9 shows exemplary production of group comparison evaluation information provided by mapping the entire communication evaluation information of different communication groups in the single evaluation field. The evaluation control section 115 produces the result of evaluation based on the group dialogue indices and the result of evaluation based on the personal utterance indices for each of the different communication groups and maps the communication groups on the evaluation field. The personal utterance evaluation information can be an average or a median of a plurality of personal utterance evaluation information pieces from each user. This applies to the personal utterance evaluation information shown in FIG. 7.

With reference to the entire communication group evaluation in FIG. 9, branch B generally has the best communication level. Branch A has a group dialogue evaluation in a “Very good” area but a personal utterance evaluation in a “Good” area, so that the personal utterance evaluation needs to be increased (improved) in terms of the entire communication group evaluation. Branch C has a personal utterance evaluation in a “Good” area but a group dialogue evaluation in a “Passed” area, so that the evaluation result can be found that the communication requires special attention to the group dialogue indices.

In the example of FIG. 9, the evaluation is divided into four areas in ascending order of “Passed,” “Good,” “Very good,” and “Excellent.” As in the branch A, when the group dialogue evaluation falls within the “Very good” area but the personal utterance evaluation falls within in the “Good” area, the entire communication group evaluation is “Good.” These areas can be divided in any manner.

FIG. 10 shows an example of entire communication evaluation information mapped in the biaxial evaluation field. The example of FIG. 10 illustrates a monthly comparison of the same group. The evaluation control section 115 can produce the group communication evaluation information and the personal utterance evaluation information at predetermined intervals in the single communication group and maps the entire communication evaluation information at predetermined intervals. In the period comparison evaluation information of FIG. 10, the personal utterance evaluation is improved from May to June, and slightly increased from June to July, while the group dialogue evaluation is increased or improved during that period. In FIG. 10, similarly to FIG. 9, the size of circles corresponds to the amount of utterance (number of utterance sentences to be evaluated).

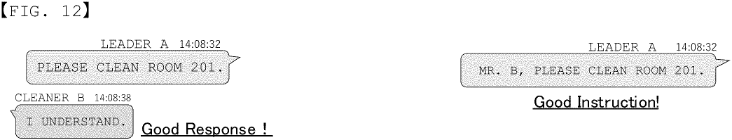

FIG. 11 is a diagram showing exemplary setting of weight values to the evaluation indices according to Embodiment 1. In evaluation of a plurality of communication groups, the same evaluation reference may be used for all the groups. However, smooth communication includes factors such as the degrees of skills of individual users belonging to the groups, experiences of communication of the users in the groups, or unique communication techniques of the users, and thus the weight values (coefficients) to the respective indices are set as a way of taking account of differences between the groups in which evaluation indices are given greater importance. Such a configuration allows setting of the criteria for evaluating group dialogues and the criteria for evaluating personal utterances in accordance with the particularities of the groups. For example, the evaluation based on group dialogue indices and the evaluation based on personal utterance indices can be performed in view of differences in work contents or attributes of working users (age group, degree of skill, gender, and nationality) to achieve the entire communication group evaluation.

In an example of FIG. 11, a dotted line represents default values of the weight value, and a solid line represents set values. For example, the response time, presence or absence of thanks, and presence or absence of confirmation of the group dialogue indices are set to be higher than the default values to reflect these indices more in the group dialogue evaluation. The bottom-up rate is set to be lower than the default value to reflect the bottom-up rate less in the group dialogue evaluation. In the weight values to the personal utterance indices, similarly, the weight values to the indices including the presence or absence of a requested user, the length of an instruction conversation, the presence or absence of a filler, and the demonstrative pronoun are set to be higher than the default values to reflect them more in the personal utterance evaluation.

As described above, the evaluation control section 115 can have the first weight value setting function of setting the weight values (first weight values) to the group dialogue indices for producing the group communication evaluation information and the second weight value setting function of setting the weight values (second weight values) to the personal utterance indices for producing the personal utterance evaluation information.

The storage apparatus 120 can hold the weight value setting information for each communication group. The first evaluation section 115A can produce the group communication evaluation information with the weight values applying thereto, and the second evaluation section 115B can produce the personal utterance evaluation information with the weight values applying thereto. For example, the sections 115A and 115B can apply the set weight values (coefficients) to the evaluation values of the indices shown in FIG. 6 and FIG. 7 and use the resulting evaluation values with the weight values applying thereto as the evaluation information of the indices and for providing the entire communication group evaluation.

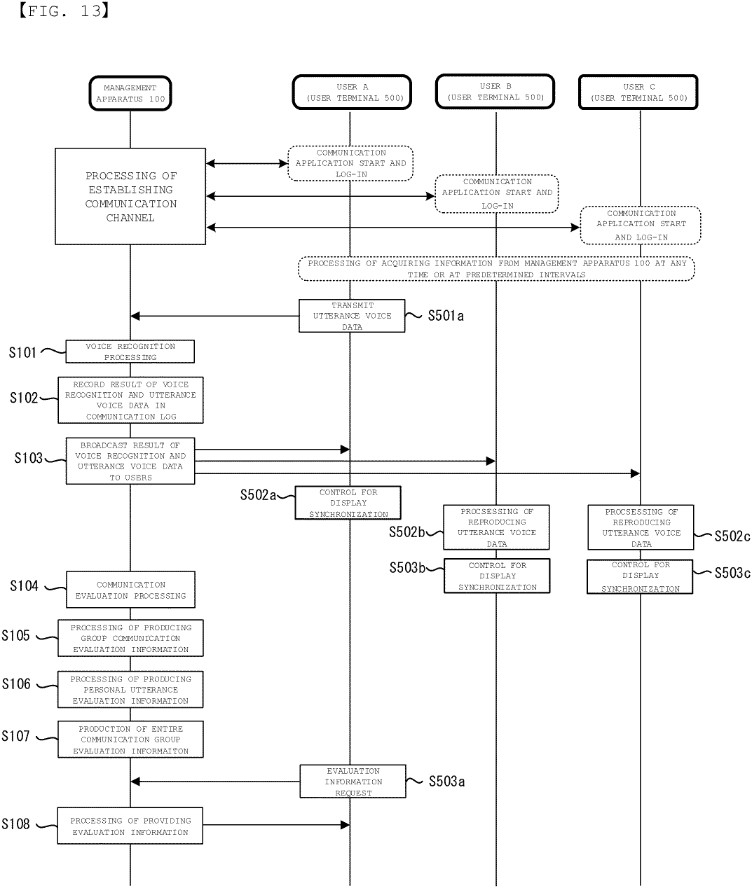

FIG. 12 is a diagram showing an example of evaluation information added to the communication log synchronized for display on the user terminals 500. In Embodiment 1, since the communication history of text form is delivered and displayed on the user terminals 500 in real time, the group dialogue evaluation information and the personal utterance evaluation information can be fed back to the users.

FIG. 12 shows an exemplary aspect in which an evaluation comment associated with evaluation information is fed back as additional information to the utterance text of the user. For example, evaluation comments associated with evaluation information based on each index can be previously provided and stored, and when evaluation information based on any index satisfies any evaluation reference, the evaluation control section 115 can extract and produce the associated evaluation comment and provide it for the user terminal 500. In an example on the left side, since the response time is less than 30 seconds, an evaluation comment “Good Response!” is fed back and added to the utterance text (result of voice recognition) of the cleaner B. In an example on the right side, since the leader A performs utterance including the name of the cleaner B corresponding to a requested user, an evaluation comment “Good Instruction!” is fed back and added to the utterance text (result of voice recognition) of the leader A.

The time of text delivery of the result of voice recognition and the time of text delivery of the evaluation comment associated with the result of evaluation based on each index can be set as appropriate in Embodiment 1. For example, the evaluation comment can be delivered together with the text delivery of the result of voice recognition (processing in the second control section), or the evaluation comment can be delivered at a time after the text delivery of the result of voice recognition, or the evaluation comment can be received at any time during works or after the completion of works in response to a request for displaying the evaluation comment from the user terminal 500.

As described above, the communication system according to Embodiment 1 produces the evaluation information based on the group dialogue indices and the personal utterance indices and provides the produced evaluation information as the evaluation result for each communication group. For the processing of feedback to the user described above, a Weak Point may also be fed back.

Specifically, the evaluation comment shown in FIG. 12 can be a comment for pointing out a weak point. The evaluation control section 115 can use the result of a comparison between the evaluation information (group communication evaluation information) based on the group dialogue indices in FIG. 6 and a predetermined threshold value or a comparison of the evaluation information between different communication groups to produce group characteristic information for each communication group (first processing). For example, when the comparison result is lower than the threshold value, the evaluation control section 115 can produce and provide the group characteristic information in the form of a weak point or an evaluation comment including a weak point, “The time to response is generally long. Try to give a quick response in the entire group.”

Similarly, the evaluation control section 115 can use the result of a comparison between the evaluation information (personal utterance evaluation information) based on the personal utterance indices in FIG. 7 and a predetermined threshold value or a comparison of the evaluation information between users to produce user characteristic information for each user (second processing). For example, when the comparison result is lower than the threshold value, the evaluation control section 115 can produce and provide the user characteristic information in the form of a weak point or an evaluation comment including a weak point, “You tend to use many demonstrative pronouns in utterance. Try to make utterances with a specific target user, place, and purpose”.

When a comparison with the predetermined threshold shows that the result is greater than the threshold value, the evaluation control section 115 can produce and provide the group characteristic information in the form of an evaluation comment including a strong point, “You generally tend to have good communication in a short time to response. Keep up the speedy response.”

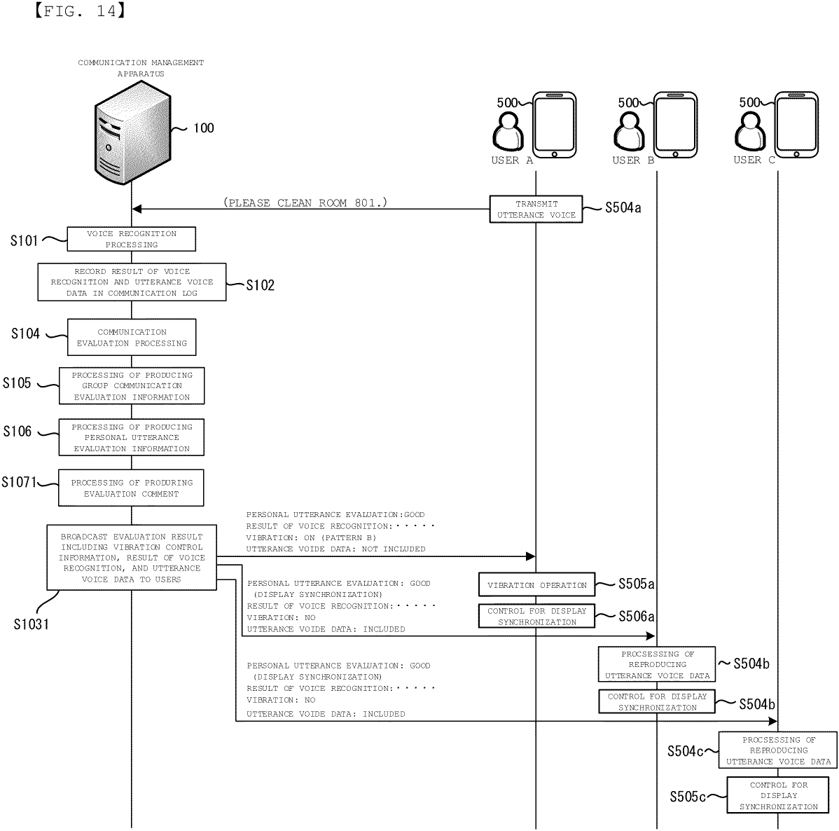

FIG. 13 is a diagram showing a flow of processing performed in the communication system according to Embodiment 1.

Each of the users starts the communication application control section 520 on his user terminal 500, and the communication application control section 520 performs processing for connection to the management apparatus 100. Each user enters his user ID and password on a predetermined log-in screen to log in to the management apparatus 100. The log-in authentication processing is performed by the user management section 111. At the second and subsequent log-ins, the input operation of the user ID and password can be omitted since the started communication application control section 520 can automatically perform log-in processing with the user ID and password input by the user at the first log-in.

After the log-in, the management apparatus 100 automatically performs processing of establishing a communication channel in a group calling mode with each of the user terminals 500 to open a group calling channel centered around the management apparatus 100.

After the log-in, each user terminal 500 performs processing of acquiring information from the management apparatus 100 at any time or at predetermined intervals.

When a user A performs utterance, the communication application control section 520 collects the voice of that utterance and transmits the utterance voice data to the management apparatus 100 (S501a). The voice recognition section 113 of the management apparatus 100 performs voice recognition processing on the received utterance voice data (S101) and outputs the result of voice recognition of the utterance content. The communication control section 112 stores the result of voice recognition in the communication history 123 and stores the utterance voice data in the storage section 120 (S102).

The communication control section 112 broadcasts the utterance voice data of the user A, who performed the utterance, to the user terminals 500 of the users other than the user A. The communication control section 112 also transmits the utterance content (in text form) of the user A stored in the communication history 123 to the user terminals 500 of the users within the communication group including the user A for display synchronization (S103).

The communication application control sections 520 of the user terminals 500 of the users other than the user A perform automatic reproduction processing on the received utterance voice data to output the reproduced utterance voice (S502b, S502c). The user terminals 500 of all the users including the user A display the utterance content of text form corresponding to the output reproduced utterance voice in the display field D (S502a, S503b, S503c).

The management apparatus 100 performs communication evaluation processing (S104). As described above, the evaluation processing is performed at any time. The evaluation control section 115 refers to the communication history information 123 to extract groups of utterances of each communication group performed in predetermined time periods such as in days or months. The evaluation control section 115 produces group communication evaluation information from the extracted groups of utterances based on the group utterance indices (S105). The evaluation control section 115 also procures personal utterance evaluation information from the individual utterances of the same groups of utterances based on the personal utterance indices (S106). The evaluation control section 115 uses the produced group communication evaluation information and personal utterance evaluation information to produce entire communication group evaluation information illustrated in FIG. 9 and/or FIG. 10 (S107).

To use the weight values described above, they are applied in the processing of steps S105 and S106. The evaluation comment or the evaluation comment including the weak point in the example of FIG. 12 can be provided at steps S105 and S106, or after the processing at step S107.

The user makes a request for evaluation information on the user terminal 500 (S503a), and the management apparatus 100 provides the evaluation information (S108) in separate processing from the delivery of the utterance voice and the result of voice recognition in the group calling (such that the evaluation information is not included in the delivered text of the result of voice recognition).

FIG. 14 is a diagram showing a flow of processing performed in the communication system according to Embodiment 1, and illustrating real-time evaluation and delivery of the evaluation result in combination with broadcast.

In an example of FIG. 14, the communication evaluation processing is performed in combination with the broadcast of utterance voice data in response to reception of the utterance voice data and the text delivery of the result of voice recognition, and the text delivery is performed such that the result of voice recognition is transmitted with an evaluation comment added thereto.

Specifically, as shown in FIG. 14, when a user A performs utterance, the utterance voice data thereof is transmitted to the management apparatus 100 (S504a), and the management apparatus 100 performs voice recognition processing on the received utterance voice data (S101). The communication control section 112 stores the result of voice recognition in the communication history 123 and stores the utterance voice data in the storage section 120 (S102).

The evaluation control section 115 performs communication evaluation processing on the result of voice recognition of the received utterance voice data (S104), produces group communication evaluation information based on the group dialogue indices (S105), and produces personal utterance evaluation information based on the personal utterance indices (S106). The evaluation control section 115 produces an evaluation comment based on the produced evaluation information (S1071).

Step S1031 shows processing including the broadcast of the utterance voice data and the text delivery of the result of voice recognition. As described above, the text delivery is performed such that the result of voice recognition is transmitted with the real-time evaluation comment produced at step S1071 added thereto. In addition, the delivery of the evaluation comment can be notification processing, for example, in cooperation with the vibration apparatus 570 of the user terminal 500 of the user who performed the utterance.

In the example of FIG. 14, the text delivery of the result of voice recognition and the evaluation comment includes transmitting a vibration control value to the user terminal 500 of the user who performed the utterance (S1031). The vibration apparatus 570 of the user terminal 500 can perform vibration operation in accordance with the received vibration control section (S505a) to notify the user of the evaluation comment.

For example, vibration control values can be preset in association with evaluation comments such that different vibration patterns (vibrating patterns) can correspond to different contents of evaluation comments as appropriate. This allows the notification using the different vibration patterns depending on the evaluation content, thereby achieving the environment in which real-time feedback is provided for the user who performed the utterance.

Embodiment 1 of the present invention has been described. The functions of the communication management apparatus 100 and the user apparatus 500 can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to perform the functions.

The program may be recorded on a computer readable recording medium and provided for the computer. Examples of the computer readable recording medium include optical disks such as a CD-ROM, phase-change optical disks such as a DVD-ROM, magneto-optical disks such as a Magnet-Optical (MO) disk and Mini Disk (MD), magnetic disks such as a floppy disk® and removable hard disk, and memory cards such as a compact flash®, smart media, SD memory card, and memory stick. Hardware apparatuses such as an integrated circuit (such as an IC chip) designed and configured specifically for the purpose of the present invention are included in the recording medium.

While an exemplary embodiment of the present invention has been described above, the embodiment is only illustrative and is not intended to limit the scope of the present invention. The novel embodiment can be implemented in other forms, and various omissions, substitutions, and modifications can be made thereto without departing from the spirit or scope of the present invention. These embodiment and variations are encompassed within the spirit or scope of the present invention and within the invention set forth in the claims and the equivalents thereof.

DESCRIPTION OF THE REFERENCE NUMERALS

| | |
|---|---|
| 100 | COMMUNICATION MANAGEMENT APPARATUS |
| 110 | CONTROL APPARATUS |
| 111 | USER MANAGEMENT SECTION |
| 112 | COMMUNICATION CONTROL SECTION (FIRST CONTROL SECTION, SECOND CONTROL SECTION) |
| 113 | VOICE RECOGNITION SECTION |
| 114 | VOICE SYNTHESIS SECTION |
| 115 | EVALUATION CONTROL SECTION |
| 115A | FIRST EVALUATION SECTION |
| 115B | SECOND EVALUATION SECTION |
| 115C | THIRD EVALUATION SECTION |
| 120 | STORAGE APPARATUS |
| 121 | USER INFORMATION |
| 122 | GROUP INFORMATION |
| 123 | COMMUNICATION HISTORY INFORMATION |
| 124 | VOICE RECOGNITION DICTIONARY |
| 125 | VOICE SYNTHESIS DICTIONARY |
| 126 | VOICE QUALITY EVALUATION INFORMATION |
| 130 | COMMUNICATION APPARATUS |
| 500 | USER TERMINAL (MOBILE COMMUNICATION TERMINAL) |
| 510 | COMMUNICATION/TALK SECTION |
| 520 | COMMUNICATION APPLICATION CONTROL SECTION |
| 530 | MICROPHONE (SOUND COLLECTION SECTION) |
| 540 | SPEAKER (VOICE OUTPUT SECTION) |
| 550 | DISPLAY INPUT SECTION |
| 560 | STORAGE SECTION |
| 570 | VIBRATION APPARATUS |
| D | DISPLAY FIELD |

1. A communication system in which a plurality of users carry their respective mobile communication terminals and a voice of utterance of one of the users input to his mobile communication terminal is broadcast to the mobile communication terminals of the other users, comprising:
a communication control section including a first control section configured to broadcast utterance voice data received from one of the mobile communication terminals to the other mobile communication terminals and a second control section configured to control text delivery such that a result of utterance voice recognition from voice recognition processing on the received utterance voice data is displayed on the mobile communication terminals in synchronization; and
an evaluation control section configured to use the result of utterance voice recognition to perform communication evaluation,
wherein the evaluation control section includes:
a first evaluation section configured to evaluate a dialogue between two or more of the users based on a group dialogue index to produce group communication evaluation information;
a second evaluation section configured to evaluate utterances constituting the dialogue between the two or more of the users based on a personal utterance index to produce personal utterance evaluation information; and
a third evaluation section configured to use the group communication evaluation information and the personal utterance evaluation information to produce entire communication group evaluation information.

2. The communication system according to claim 1, wherein the evaluation control section is configured to produce the group communication evaluation information and the personal utterance evaluation information for different individual communication groups, and
the third evaluation section is configured to produce group comparison evaluation information, the group comparison evaluation information being provided by mapping the entire communication evaluation information produced for each of the individual different communication groups on a single evaluation field.

3. The communication system according to claim 1, wherein the evaluation control section is configured to produce the group communication evaluation information and the personal utterance evaluation information for the communication group in predetermined time periods, and
the third evaluation section is configured to produce period comparison evaluation information, the period comparison evaluation information being provided by mapping the entire communication evaluation information produced in each of the predetermined time periods on a single evaluation field.

4. The communication system according to claim 1, wherein the third evaluation section is configured to produce the entire communication group evaluation information including an evaluation field represented on a vertical axis and a horizontal axis, the vertical axis and the horizontal axis being associated with the personal utterance evaluation information and the group communication evaluation information, respectively.

5. The communication system according to claim 1, wherein the group dialogue index includes a response time of utterance between the two or more of the users, the presence or absence of a specific keyword in the utterances constituting the dialogue, the presence or absence of confirmation of a message, and/or the presence or absence of utterance relating to a spontaneous action, and the personal utterance index includes the presence or absence of the proper noun of a contacted user of the two or more of the users, the presence or absence of message redundancy, and/or the presence or absence of a demonstrative pronoun in the utterances.

6. The communication system according to claim 1, wherein the evaluation control section is configured to perform:
first processing of producing, based on a result of a comparison between the group communication evaluation information and a predetermined threshold value or a result of a comparison of the group communication evaluation information between communication groups, group characteristic information for each of the communication groups; and
second processing of producing, based on a result of a comparison between the personal utterance evaluation information and a predetermined threshold value or a result of a comparison of the personal utterance evaluation information between users, user characteristic information.

7. The communication system according to claim 1, wherein the group dialogue index comprises a plurality of group dialog indices and the personal utterance index comprises a plurality of personal utterance indices, and the evaluation control section includes a first weight value setting section configured to set a first weight value to each of the plurality of group dialogue indices for producing the group communication evaluation information and a second weight value setting section configured to set a second weight value to each of the plurality of personal utterance indices for producing the personal utterance evaluation information,
information for setting the first weight value and information for setting the second weight value are held for individual communication groups,
the first evaluation section is configured to produce the group communication evaluation information with the first weight value applying thereto, and
the second evaluation section is configured to produce the personal utterance evaluation information with the second weight value applying thereto.

8. The communication system according to claim 1, wherein the communication control section is configured to deliver an evaluation comment based on the group communication evaluation information and/or an evaluation comment based on the personal utterance evaluation information in text form as additional information to the result of utterance voice recognition in the control of text delivery of the result of utterance voice recognition.

9. A method of evaluating communication in a communication group in which a plurality of users carry their respective mobile communication terminals and a voice of utterance of one of the users input to his mobile communication terminal is broadcast to the mobile communication terminals of the other users, comprising:
a first step of broadcasting utterance voice data received from one of the mobile communication terminals to the other mobile communication terminals and controlling text delivery such that a result of utterance voice recognition from voice recognition processing on the received utterance voice data is displayed as a communication history on the mobile communication terminals in synchronization; and
a second step of using the result of utterance voice recognition provided at the first step to perform communication evaluation,
wherein the second step includes:
a third step of evaluating a dialogue between two or more of the users based on a group dialogue index to produce group communication evaluation information;
a fourth step of evaluating utterances constituting the dialogue between the two or more of the users based on a personal utterance index to produce personal utterance evaluation information; and
a fifth step of using the group communication evaluation information and the personal utterance evaluation information to produce entire communication group evaluation information.

10. A program comprising instructions executable by a management apparatus connected to mobile communication terminals carried by their respective users, the management apparatus being configured to broadcast a voice of utterance of one of the users input to his mobile communication terminal to the mobile communication terminals of the other users, wherein the instructions, when executed by the management apparatus, cause the management apparatus to provide:
a first function of broadcasting utterance voice data received from one of the mobile communication terminals to the other mobile communication terminals;
a second function of controlling text delivery such that a result of utterance voice recognition from voice recognition processing on the received utterance voice data is displayed on the mobile communication terminals in synchronization; and
a third function of using the result of utterance voice recognition to perform communication evaluation,
wherein the third function includes:
a function of evaluating a dialogue between two or more of the users based on a group dialogue index to produce group communication evaluation information;
a function of evaluating utterances constituting the dialogue between the two or more of the users based on a personal utterance index to produce personal utterance evaluation information; and
a function of using the group communication evaluation information and the personal utterance evaluation information to produce entire communication group evaluation information.
